(19) United States
(12) Patent Application Publication
(10) Pub. No.: US 2009/0249906 A1
(43) Pub. Date: Oct. 8, 2009

(54) Linear Actuator

(76) Inventors: Tung-Hsin Chen, Taichung (TW); Hsin-An Chiang, Taichung (TW)

Correspondence Address: Dr. BANGER SHIA, 102 Lindencrest Ct., Sugar Land, TX, 77479-5201, US

(21) Appl. No.: 12/098,451

(22) Filed: Apr. 6, 2008

(51) Int. Cl. F16H 27/02

(52) U.S. Cl. 74/89.37

(57) ABSTRACT

A linear actuator comprises an outer pipe, a middle pipe and an inner pipe, and the pipes are hollow polygonal pipes and are mounted orderly. A bottom of the outer pipe is disposed with a pushing device and a rolling device. The pushing device having a screw and a nut that are screwed with each other. A pulling member is driven to move the inner pipe and is fixed between the inner pipe and the outer pipe by cooperating with a pulley disposed on the middle pipe and a steel wire, such that the pipes can be synchronously moved in an axial direction. The steel wire winds around a rolling shaft of the rolling device, such that the steel wire can be loosened or tightened along with the pipes, enabling the pipes to extend or retract more stably.

### BACKGROUND OF THE INVENTION

1. Field of the Invention

The present invention relates to a linear actuator, and more particularly to a transmission device which can be radially restricted but can perform a stable axial extending/retracting movement.

2. Description of the Prior Art

The use of linear actuators is quite extensive, and the current linear actuators are generally driven by motors to extend or retract other mechanisms. Referring to FIGS. 1 and 2, a conventional linear actuator 90 disclosed in U.S. Pat. No. 6,880,416 is disposed with a three-segment telescopic structure consisting of three pipes 91, 92 and 93, in which is disposed a motor 94. The motor 94 is used to drive a screw structure 95 disposed with three screws 96, 97 and 98. The screws 96, 97 and 98 are connected to the telescopic pipes 91, 92 and 93 of the linear actuator 90, respectively. The motor 94 drives the screws 96, 97 and 98 to move in the axial direction, so that the telescopic pipes 91, 92 and 93 can be driven to extend or retract.

The above-mentioned configuration and structure can extend or retract, but it still has the following disadvantages:

Firstly, complicated in structure and inconvenient to assemble: the screws 96, 97 and 98 push the respective telescopic pipes 91, 92 and 93 of the linear actuator 90, respectively, the three-segment screw structure makes the linear actuator 90 complicated in structure and inconvenient to assembly.

Secondly, high cost: the telescopic pipes 91, 92 and 93 of the above-mentioned linear actuator 90 are connected to the screws 96, 97 and 98, respectively, such a design increases the cost of manufacturing the linear actuator 90.

Referring to FIGS. 3 and 4, another conventional linear actuator 80 disclosed in EP Pat. No. 0982018 comprises a circular-shaped three-segment telescopic structure consisting of three pipes 81, 82 and 83, in which a motor 84 and a screw 85 are disposed. The motor 84 and the screw 85 are disposed in the telescopic pipe 81, and the motor 84 drives the screw 85 to rotate. The screw 85 rotates a supporting rod by cooperating with threads, and a top of the supporting rod is disposed with a pulley 86, thus causing an axial displacement of the telescopic pipe 81. The pulley 86 serves as a movable pulley to drive another telescopic pipe 83 to move in the axial direction by cooperating with a chain, so as to drive the telescopic pipes 81, 82 and 83 to extend or retract.

The above-mentioned configuration and structure can extend or retract, but it still has the following disadvantages:

Firstly, it is likely to cause internal damage: the three-segment telescopic pipes 81, 82 and 83 are designed as a circular-shaped pipe, and the circular-shaped three-segment telescopic pipes 81, 82 and 83 have no engaging and restricting structure, such a design is likely to cause damage to the internal structure due to the radial rotation and abrasion while the motor 84 drives the screw 85 to rotate.

Secondly, the movement will cause mutual interference: with the displacement of the pulley 86 at the top of the supporting rod, the screw 85 drives the telescopic pipe 83 to orderly move the telescopic pipe 82 and other structures via the chain. In addition, between the bottom of the telescopic pipe 82 and the screw 85 is disposed a restricting structure which causes the unnecessary interference during the pulling process of the restricting structure and the chain, thus affecting the extending/retracting movement of the conventional linear actuator.

The present invention has arisen to mitigate and/or obviate the afore-described disadvantages.

### SUMMARY OF THE INVENTION

The primary objective of the present invention is to provide a linear actuator which comprises a hollow polygonal outer pipe provided for insertion of a middle pipe and an inner pipe. The inner pipe is disposed with a pushing device and a rolling device. The pushing device engages with and rotates the rolling device. The pushing device includes a screw and a nut that are threaded with each other. The nut is fixed to the bottom of the pushing pole and is movably restricted in the end of the middle pipe. The pushing pole is disposed with a pulley, and a pulling member is wound around the pulley. One end of the pulling member is fixed in the inner pipe, and the other end of the pulling member is connected to the bottom of the outer pipe. The bottom of the middle pipe is disposed with a plurality of pulleys, and a steel wire is wound around the pulleys. One end of the steel wire is fixed to an inner diameter of the outer pipe, and the other end of the steel wire is fixed to one end of the inner pipe. The rolling device is disposed with a rolling shaft moving along with the screw. One end of the steel wire winds around the rolling shaft, and the other end of the steel wire is fixed at the inner pipe.

The screw drives the nut to move, the nut drives the pushing pole to move in the axial direction and synchronously drives the pulling member to move the inner pipe, causing axial retraction and extension of the inner pipe. At the same time, the steel wires drive the middle pipe and the outer pipe to extend or retract. The polygonal configurations can be used to perform a restricting extending/retracting movement, so that the linear actuator can be extend or retracted smoothly without causing interference, and can be moved stably. In addition, the steel wire winds around the rolling shaft of the rolling device, when loosening or tightening the steel wire, the inner pipe can be extended or retracted stably, such that the linear actuator can be extend or retract stably and can be restricted with respect to one another in a radial direction

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a side view of a conventional linear actuator;

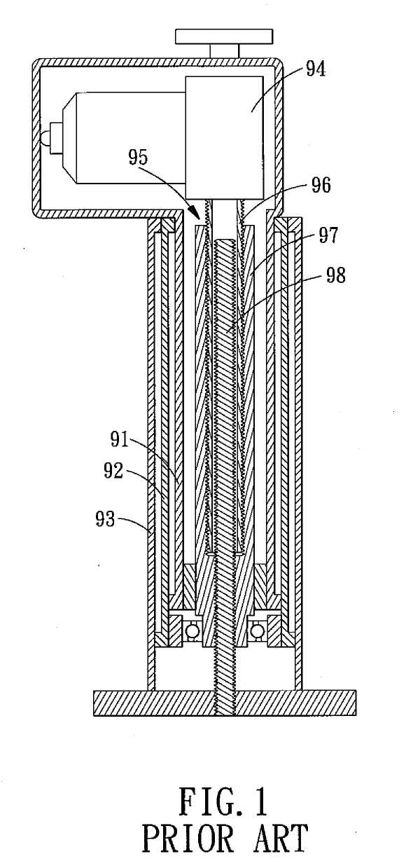

FIG. 2 is a side view showing the extension of the conventional linear actuator;

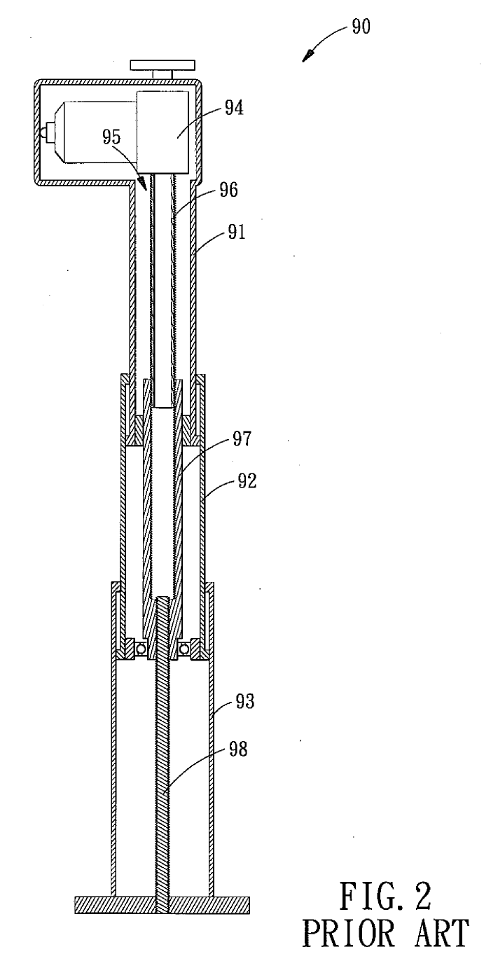

FIG. 3 is a side view of another conventional linear actuator;

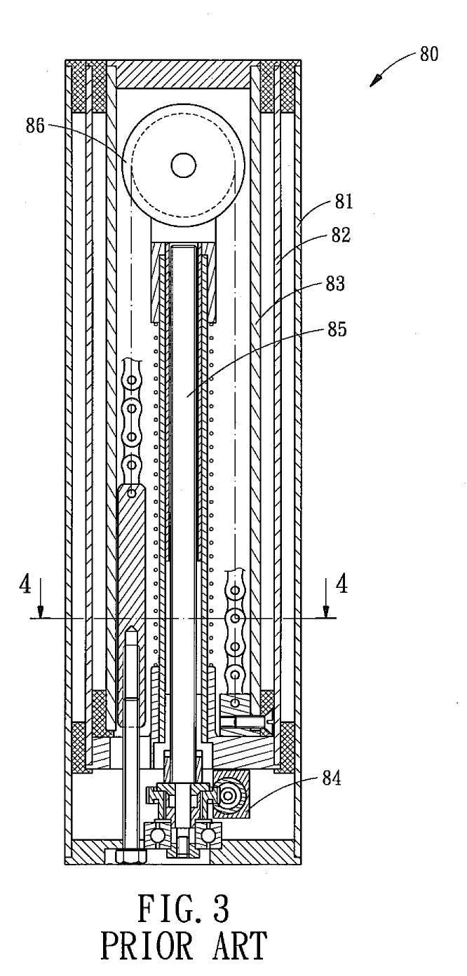

FIG. 4 is a top view of another conventional linear actuator;

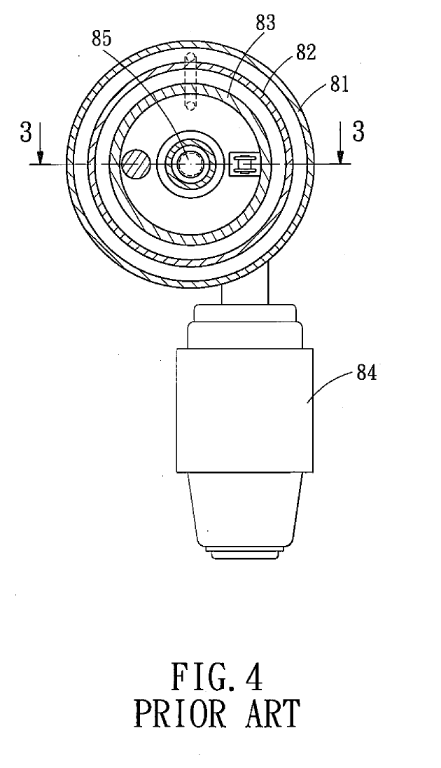

FIG. 5 is a top view of a linear actuator in accordance with the present invention;

FIG. 6 is a partial perspective view of the linear actuator in accordance with the present invention;

FIG. 7 is a cross sectional view showing the action of the linear actuator in FIG. 6 in accordance with the present invention; and

FIG. 8 is a cross sectional view showing the extension of the linear actuator in FIG. 6 in accordance with the present invention.

### DETAILED DESCRIPTION OF THE PREFERRED EMBODIMENTS

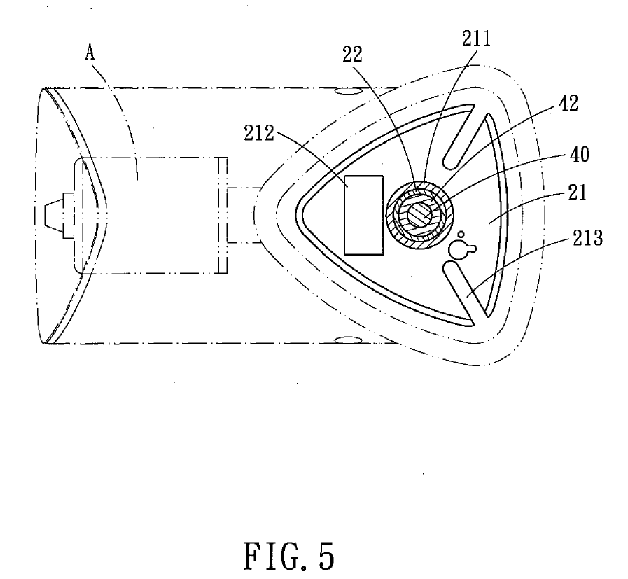

Referring to FIGS. 5-7, a linear actuator in accordance with the present invention comprises a hollow polygonal outer pipe 10 for insertion of a middle pipe 20 and an inner pipe 30 that are in the same shape as the outer pipe 10. With the polygonal configurations, the outer pipe 10, the middle pipe 20 and the inner pipe 30 can extend or retract with respect to one another in an axial direction and can be restricted with respect to one another in a radial direction, thus keeping the stability of the extending/retracting movement. The cross section of the respective polygonal pipes 10, 20, 30 can be in the form of a hollow triangle, quadrangle or pentagon. In a center of a bottom of the outer pipe 10 is disposed a pushing device 40 that engages with a rolling device 60. The pushing device 40 can drive the inner pipe 30 and the middle pipe 20 to move in the axial direction. A pulling member 50 is disposed in the inner pipe 30. One end of the pulling member 50 is fixed to the outer pipe 10, and the other end of the pulling member 50 is fixed at a bottom of the inner pipe 30. A middle portion of the pulling member 50 is pushed by the pushing device 40, and the other end of the pulling member 50 pulls the inner pipe 30 and pushes the middle pipe 20 to move in the axial direction. Simultaneously, the pushing member 50 drives the rolling device 60 to rotate, enabling the rolling device 60 to stably drive the inner pipe 30 to extend or retract in the axial direction. Thereby, the linear actuator allows the respective pipes 10, 20, 30 to axially extend or retract relative to one another with the least interference while preventing them from moving relative to one another in radial direction, thus keeping the stability of the extending/retracting movement. The outer pipe 10 is a hollow polygonal pipe disposed with the pushing device 40 at the bottom thereof. The outer pipe 10 is disposed with a positioning pole 11 adjacent to the pushing device 40. The positioning pole 11 is provided for positioning the pulling member 50. The outer pipe 10 is provided for orderly insertion of the middle pipe 20 and the inner pipe 30.

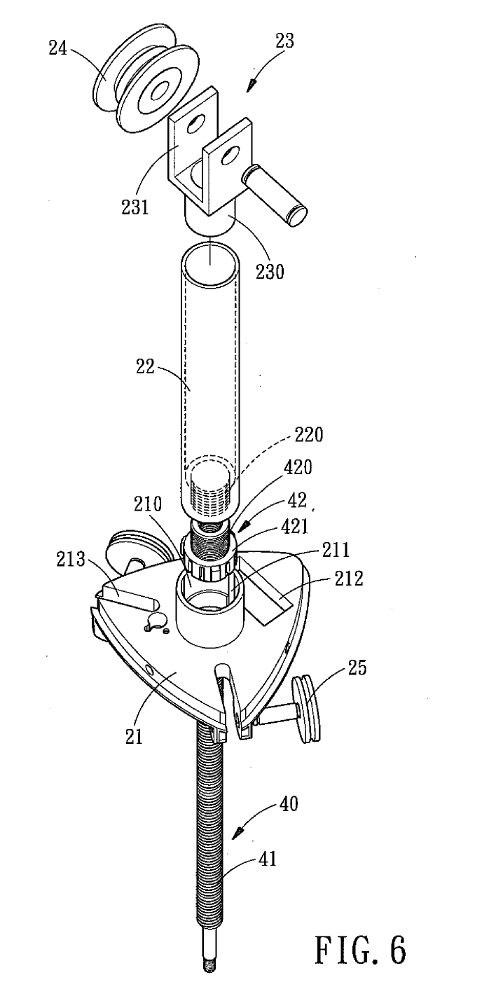

The middle pipe 20 is a hollow polygonal pipe disposed with a triangular connecting plate 21 having the same shape as the middle pipe 20 at the bottom thereof. Referring to FIG. 6, in a center of the connecting plate 21 is defined a circular-shaped receiving portion 210, which is in the form of a circular hole for receiving the pushing device 40 and a hollow cylinder-shaped pushing pole 22. In an inner periphery of the receiving portion 210 is equidistantly disposed a plurality of elongated sliding grooves 211 along the extending/retracting direction for mounting and restricting the pushing device 40. One end of the pushing pole 22 is defined with inner threads 220 towards the receiving portion 210. The inner threads 220 are threaded with a corresponding member disposed in the pushing device 40. The other end of the pushing pole 22 is disposed with a three-dimensional Y-shaped pivotal body 23. One end of the pivotal body 23 is disposed with a cylinder-shaped inserting portion 230 that is inserted into the other end of the pushing pole 22. The other end of the pivotal body 23 is a U-shaped pivotal portion 231 for pivotally disposing a pulley 24, and the pulling member 50 is wound around the pulley 24.

One end of the connecting plate 21 is disposed with a rectangular inserting portion 212 for insertion of the positioning pole 11 and the pulling member 50. Each of the other two ends of the connecting plate 21 is disposed with a slot 213. An open end of each slot 213 is pivotally disposed with a pulley 25 that is equipped with a steel wire 26. One end of each steel wire 26 is fixed in the outer pipe 10, and the other end of each steel wire 26 is orderly passed through the slot 213 of the connecting plate 21 at the bottom of the middle pipe 20 to the inner pipe 30 and is fixed at a top of the inner pipe 30.

The inner pipe 30 is a hollow polygonal pipe inserted into the middle pipe 20. The bottom of the inner pipe 30 is provided for fixing one end of the pulling member 50.

The pushing device 40 includes a screw 41 and a nut 42 that are threaded with each other. The screw 41 is pivotally disposed at the bottom of the outer pipe 10 and is driven by a motor. An inner diameter of the nut 42 is threaded with the screw 41, and an outer portion of the nut 42 is defined with outer threads 420 to be threaded with the inner threads 220 of the pushing pole 22. The nut 42 is mounted in the receiving portion 210 of the connecting plate 21 after being threaded. In an outer periphery of the nut 42 is equidistantly disposed a plurality of sliding portions 421 along the extending/retracting direction for engaging with the sliding grooves 211 of the connecting plate 21.

The pulling member 50 is wound around the pulley 24 of the pushing pole 22 and includes a first positioning end 51 and a second positioning end 52. The first positioning end 51 is fixed at one end of the positioning pole 11, and the second positioning end 52 is fixed at the bottom of the inner pipe 30.

The pulling member 50 can be a belt, a chain or a steel wire.

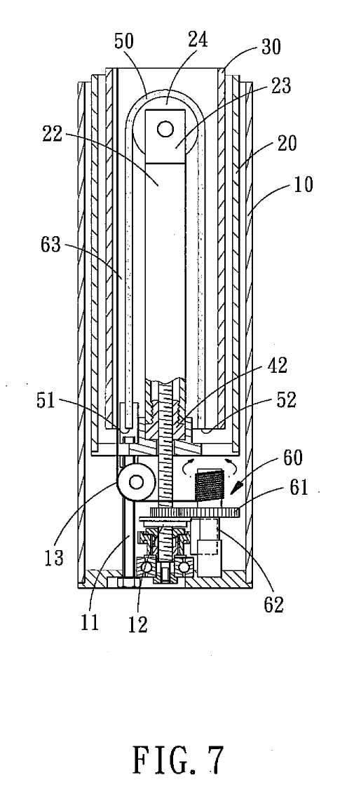

Referring to FIG. 7, the rolling device 60 is disposed with a disk-shaped rotating disk 61, a rolling shaft 62 and a steel wire 63. The rotating disk 61 engages with and rotates the screw 41 of the pushing device 40. The cylinder-shaped rolling shaft 62 is pivotally passed through the rotating disk 61. One end of the steel wire 63 winds around the rolling shaft 62, and the other end of the steel wire 63 fixed at the top of the inner pipe 30 via a pulley 13 pivotally disposed on the positioning pole 11.

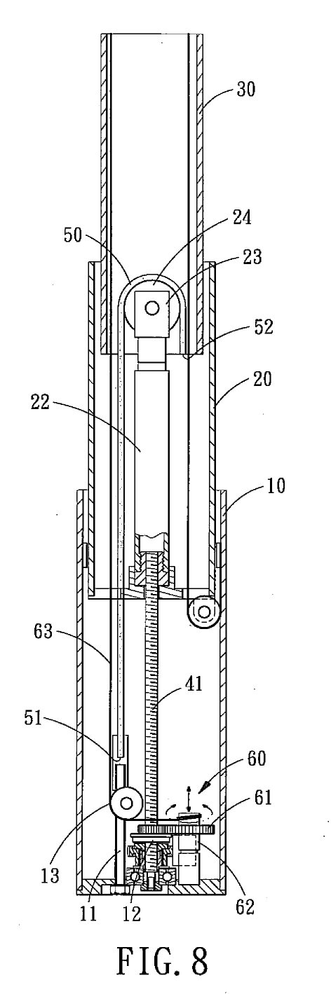

Referring further to FIG. 7, when the motor drives the screw 41 of the pushing device 40 to rotate, since the sliding grooves 211 and the sliding portions 421 are the radial engaging structures of the receiving portion 210 of the connecting plate 21 and the nut 42, respectively, the nut 42 is only allowed to move axially but not radially, that is, the nut 42 is kept from rotating but moves with respect to the screw 41 in the axial direction and synchronously drives the pushing pole 22 and the pulley 24 to push the middle portion of the pulling member 50, causing axial retraction and extension of the inner pipe 30. At the same time, the screw 41 engages with and rotates the rotating disk 61 of the rolling device 60, the rotating disk 61 rotates the rolling shaft 62, and the rolling shaft 62 cooperates with the pulley 13 and the traction of the steel wire 62 to loosen the steel wire 63, such that the rolling device 60 can be extended or retracted in the axial direction under the condition of a certain predetermined force to the position as shown in FIG. 8. When the screw 41 is rotated in a counterclockwise direction, the steel wire 63 can be synchronously driven to retract, enabling the inner pipe 30 to retract more stably, thus achieving a stable axial extending/retracting movement.

With the above-mentioned structures, the present invention has the following advantages:

Firstly, stable restricting extending/retracting movement: the outer pipe 10, the middle pipe 20 and the inner pipe 30 are designed as the hollow polygonal pipe, and the outer pipe 10 is provided for insertion of the middle pipe 20 and the inner pipe 30, such that the outer pipe 10, the middle pipe 20 and the inner pipe 30 can be restrictedly extended or retracted with respect to one another in the axial direction.

Secondly, improving the smoothness of the extending/retracting movement of the linear actuator: between the connecting plate 21 of the middle pipe 20 and the pushing device 40 is formed an axial margin, so that the middle pipe 20 has a certain extent of margin with respect to the pushing device 40 when being pulled by the steel wire 26, so as to reduce the interference during the extending/retracting movement, thus improving the smoothness of the extending/retracting movement, even when the steel wire 26 improperly extends or retracts, the smoothness of the extending/retracting movement can be ensured.

Thirdly, convenience of production, check and assembly: the arrangement of the nut 42 and the pushing pole 22 of the middle pipe 20 provides convenience of production, check and assembly, which also reduces the interference of the respective pipes, lowers the noise and smoothes the extending and retracting movement during the extension and retraction of the outer pipe 10, the middle pipe 20 and the inner pipe 30.

While we have shown and described various embodiments in accordance with the present invention, it should be clear to those skilled in the art that further embodiments may be made without departing from the scope of the present invention.

What is claimed is:

1. A linear actuator, comprising:
a hollow polygonal outer pipe for insertion of a middle pipe and an inner pipe that are in the same shape as the outer pipe;
a pushing device disposed at a bottom of the outer pipe and engaged with a rolling device;
a pulling member, one end of the pulling member being fixed at a bottom of the inner pipe, the other end of the pulling member being fixed to the outer pipe, a middle portion of the pulling member being pushed by the pushing device, simultaneously, the rolling device being driven by the pushing member to rotate;
a bottom of the middle pipe being disposed with a connecting plate, a pushing pole being mounted at a center of the connecting plate, at a top of the pushing pole being disposed a pulley abutted against a middle portion of the pulling member, one end of the connecting plate being disposed with a pulley that is equipped with a steel wire, one end of the steel wire being fixed in the outer pipe, the other end of the steel wire being passed through the middle pipe to the inner pipe and being fixed at a top of the inner pipe;
the pushing device having a screw and a nut that are threaded with each other, the screw being pivotally disposed at a bottom of the outer pipe and being driven by a motor, an inner diameter of the nut being threaded with the screw, an outer portion of the nut being connected to the pushing pole, sliding grooves and sliding portions being radial engaging structures of receiving portion of the connecting plate and the nut, respectively;
the rolling device being disposed with a rotating disk, a rolling shaft and a steel wire, the rotating disk being engaged with the screw of the pushing device, the rolling shaft being passed through the rotating disk, one end of the steel wire of the rolling device winding around the rolling shaft, the other end of the steel wire of the rolling device being fixed at the top of the inner pipe, and the rotating disk being synchronously driven to loosen or tighten the steel wire of the rolling device.

2. The linear actuator as claimed in claim 1, wherein the outer pipe is disposed with the pushing device at the bottom thereof and is disposed with a positioning pole adjacent to the pushing device, and one end of the pulling member is fixed to the positioning pole.

3. The linear actuator as claimed in claim 1, wherein the middle pipe is disposed with a triangular connecting plate having the same shape as the middle pipe at the bottom thereof, in a center of the connecting plate is defined a circular-shaped receiving portion which is in a form of a circular hole for mounting the pushing device and the hollow cylinder-shaped pushing pole, in an inner periphery of the receiving portion is equidistantly disposed a plurality of elongated sliding grooves along an extending/retracting direction of the respective pipes for mounting and restricting the pushing device, one end of the pushing pole is defined with inner threads towards the receiving portion, the inner threads are threaded with a corresponding member disposed in the pushing device, the other end of the pushing pole is disposed with a three-dimensional Y-shaped pivotal body, one end of the pivotal body is disposed with a cylinder-shaped inserting portion that is inserted into the other end of the pushing pole, the other end of the pivotal body is a U-shaped pivotal portion for pivotally disposing a pulley, and the pulley of the pivotal portion is provided for movably disposing the pulling member.

4. The linear actuator as claimed in claim 1, wherein one end of the connecting plate is disposed with a rectangular inserting portion for insertion of a positioning pole and the pulling member, each of the other two ends of the connecting plate is disposed with a slot, an open end of each slot is pivotally disposed with a pulley that is equipped with a steel wire, one end of the steel wire of the pulley of each slot is fixed in the outer pipe, and the other end of the steel wire of the pulley of each slot is orderly passed through the slot of the connecting plate at the bottom of the middle pipe to the inner pipe and is fixed at a top of the inner pipe.

5. The linear actuator as claimed in claim 2, wherein one end of the connecting plate is disposed with a rectangular inserting portion for insertion of a positioning pole and the pulling member, each of the other two ends of the connecting plate is disposed with a slot, an open end of each slot is pivotally disposed with a pulley that is equipped with a steel wire, one end of the steel wire of the pulley of each slot is fixed in the outer pipe, and the other end of the steel wire of the pulley of each slot is orderly passed through the slot of the connecting plate at the bottom of the middle pipe to the inner pipe and is fixed at a top of the inner pipe.

6. The linear actuator as claimed in claim 3, wherein one end of the connecting plate is disposed with a rectangular inserting portion for insertion of the positioning pole and the pulling member, each of the other two ends of the connecting plate is disposed with a slot, an open end of each slot is pivotally disposed with a pulley that is equipped with a steel wire, one end of the steel wire of the pulley of each slot is fixed in the outer pipe, and the other end of the steel wire of the pulley of each slot is orderly passed through the slot of the connecting plate at the bottom of the middle pipe to the inner pipe and is fixed at a top of the inner pipe.

7. The linear actuator as claimed in claim 1, wherein the nut of the pushing device is defined with outer threads to be threaded with inner threads of the pushing pole, the nut is mounted in a receiving portion of the connecting plate after being threaded, in an outer periphery of the nut is equidistantly disposed a plurality of sliding portions along an extending/retracting direction of the respective pipes for engaging with the sliding grooves of the connecting plate.

8. The linear actuator as claimed in claim 3, wherein the nut of the pushing device is defined with outer threads to be threaded with the inner threads of the pushing pole, the nut is mounted in the receiving portion of the connecting plate after being threaded, in an outer periphery of the nut is equidistantly disposed a plurality of sliding portions along the extending/retracting direction of the respective pipes for engaging with the sliding grooves of the connecting plate.

9. The linear actuator as claimed in claim 1, wherein the pulling member is wound around the pulley of the pushing pole and includes a first positioning end and a second positioning end, the first positioning end is fixed at one end of a positioning pole, and the second positioning end is fixed at the bottom of the inner pipe.

10. The linear actuator as claimed in claim 1, wherein the pulling member is selected from the group consisting of a belt, a chain and a steel wire.

11. The linear actuator as claimed in claim 1, wherein the rolling device is disposed with the disk-shaped rotating disk, the rolling shaft and the steel wire, the rotating disk engages with and rotates the screw of the pushing device, the cylinder-shaped rolling shaft is pivotally passed through the rotating disk, one end of the steel wire of the rolling device winds around the rolling shaft, and the other end of the steel wire of the rolling device is fixed at the top of the inner pipe via a pulley pivotally disposed on a positioning pole.

12. The linear actuator as claimed in claim 1, wherein the outer pipe, the middle pipe and the inner pipe are triangular, in cross section.

13. The linear actuator as claimed in claim 1, wherein the outer pipe, the middle pipe and the inner pipe are tetragonal in cross section.

14. The linear actuator as claimed in claim 1, wherein the outer pipe, the middle pipe and the inner pipe are pentagonal in cross section.
